(19) United States
(12) Patent Application Publication
(10) Pub. No.: US 2020/0005379 A1
(43) Pub. Date: Jan. 2, 2020

(54) RECOMMENDING FOOD SELECTIONS BASED ON ANALYSIS OF NUTRIENTS

(71) Applicant: International Business Machines Corporation, Armonk, NY (US)

(72) Inventors: Paul R. BASTIDE, Boxford, MA (US); Matthew E. BROOMHALL, Goffstown, NH (US); Robert E. LOREDO, North Miami Beach, FL (US)

(21) Appl. No.: 16/023,349

(22) Filed: Jun. 29, 2018

(51) Int. Cl. G06Q 30/06; G06F 17/30

(52) U.S. Cl. CPC G06Q 30/0627; G06Q 30/0633; G06F 17/30867

(57) ABSTRACT

Embodiments generally relate to food selection recommendations based on an analysis of nutrients. In some embodiments, a method includes determining food items for purchase. The method further includes determining nutrients contained in the food items. The method further includes determining nutrient values for each nutrient. The method further includes aggregating the nutrient values for each nutrient as the nutrient values decrease over time. The method further includes determining if one or more of the aggregated nutrient values for one or more of the respective nutrients fall below respective nutrition thresholds. The method further includes recommending to a user one or more of the substitute food items or supplemental food items.

### BACKGROUND

For overall good health, a person should keep specific nutrients at optimal levels. Often, however, people buy food items without regard to nutrient value, which can adversely impacting their health as a result. Conventional solutions include a system of printing out labels or packaging that includes percentages of daily values for nutrients. The information provided, however, is limited to one food item and does not provide a broader assessment of nutrient consumption.

### SUMMARY

Disclosed herein is a method for recommending food selections based on analysis of nutrients, and a system and computer program product as specified in the independent claims. Embodiments are given in the dependent claims. Embodiments can be freely combined with each other if they are not mutually exclusive.

Embodiments recommend food selections based on analysis of nutrients. In an embodiment, a method includes determining food items for purchase; determining nutrients contained in the food items; and determining nutrient values for each nutrient. The method further includes aggregating the nutrient values for each nutrient as the nutrient values decrease over time, and determining if one or more of the aggregated nutrient values for one or more of the respective nutrients fall below respective nutrition thresholds. The method further includes recommending to a user one or more of the substitute food items or supplemental food items.

In another embodiment, to determine the food items, the method further includes obtaining an electronic shopping list, where the food items are listed on the electronic shopping list; and reading the food items from the electronic shopping list. In another aspect, the food items are scanned by a scanner. Also, to determine the food items, the method further includes receiving scanned information associated with the food items. In another aspect, to determine the nutrient values for each of the nutrients, the method further includes determining a quantity of each food item; and determining the nutrient values for each nutrient based on the quantity of each food item. In another aspect, the method further includes determining a nutrition threshold for each nutrient, where the nutrition threshold is based on one or more of clinical data and exogenous data. In another aspect, the method further includes presenting to a user each nutrient where the associated aggregated nutrient value falls below the respective nutrition threshold. In another aspect, the method further includes determining one or more food preferences of a user; and recommending the one or more substitute food items or supplemental food items based on the food preferences.

### BRIEF DESCRIPTION OF THE DRAWINGS

FIG. 1 is an example environment for providing food selection recommendations based on an analysis of nutrients, according to some embodiments.

FIG. 2 is an example flow diagram for recommending food selections based on analysis of nutrients, according to some embodiments.

FIG. 3 is an example graph showing the decrease in nutrient values of a food item over time, according to some embodiments.

FIG. 4 is an example graph showing current aggregate nutrient values compared to target nutrient values of two example nutrients, according to some embodiments.

FIG. 5 is a block diagram of an example computer system, which may be used for embodiments described herein.

### DETAILED DESCRIPTION

Embodiments described herein provide food selection recommendations based on analysis of nutrients. Embodiments assess the aggregate nutrient values of food items in a shopping cart and recommend food item substitutes and/or supplements based on nutrition gaps associated with the aggregate nutrient values.

In some embodiments, a system determines food items for purchase, nutrients contained in the food items, and nutrient values for each nutrient. The system aggregates the nutrient values for each nutrient as the nutrient values decrease over time, and determines if one or more of the aggregated nutrient values for one or more of the respective nutrients fall below respective nutrition thresholds. The system then recommends to a user one or more of the substitute food items or supplemental food items.

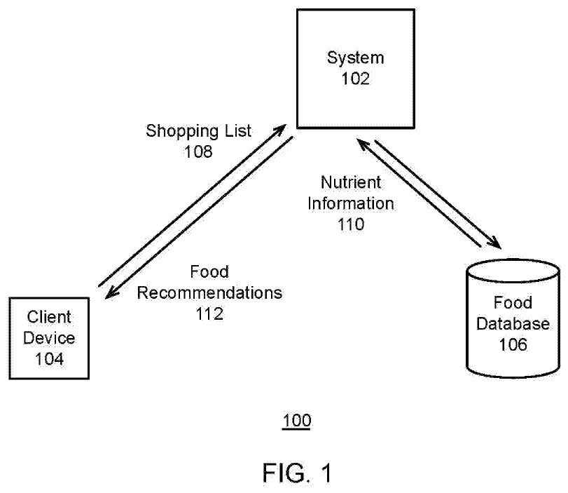

FIG. 1 is an example environment 100 for providing food selection recommendations based on an analysis of nutrients, according to some embodiments. Shown are a system 102, a client device 104, and a food database 106. In various embodiments, system 102, client device 104, and food database 106 may communicate with each other using any suitable network or combination of networks.

As described in more detail herein, system 102 determines food items from a shopping list 108 received from a user via client device 104. System 102 determines nutrients in the food items and associated nutrient information 110 from one or more databases such as food database 106. Nutrient information may include, for example, nutrient values for each nutrient, recommended nutrient amounts, etc. Based on nutrient information 110, system 102 determines nutrient gaps and provides recommendations for substitute food items and/or supplemental food items in order to help the user to purchase food items that have optimal levels of multiple nutrients.

For ease of illustration, FIG. 1 shows one block for each of system 102, client device 104, and food database 106. Blocks 102, 104, and 106 may represent multiple systems, client devices, and food databases. In other implementations, environment 100 may not have all of the components shown and/or may have other elements including other types of elements instead of, or in addition to, those shown herein.

While the system 102 performs embodiments described herein, in other embodiments, any suitable component or combination of components associated with the system 102 or any suitable processor or processors associated with the system 102 may facilitate performing the embodiments described herein. In various embodiments, the environment 100 may not have all of the components shown and/or may have other elements including other types of components instead of, or in addition to, those shown herein.

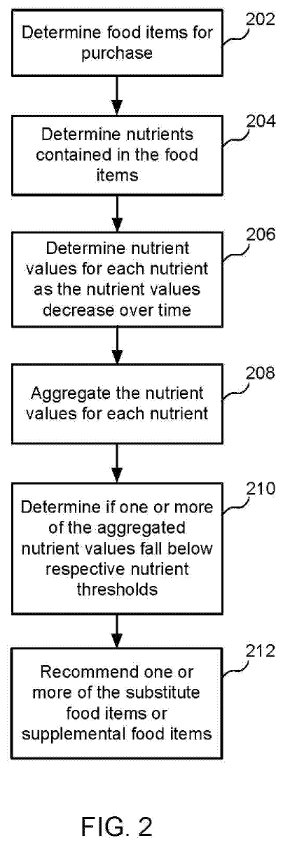

FIG. 2 is an example flow diagram for recommending food selections based on analysis of nutrients, according to some embodiments. As described in more detail herein, the system detects food items for purchase and/or in a purchase history of a shopping cart. The system suggests alternative and/or supplemental purchases based on nutrient gaps associated with the food items.

Referring to both FIGS. 1 and 2, a method begins at block 202, where a system such as system 102 determines food items for purchase by a user. For example, as the user shops, the system continually identifies food items for purchase (e.g., by the user scanning item barcodes on the user's cell phone, using a store customer card and in-store scanner where results are displayed to the user on an in-store or on the user's cell phone via a mobile application, etc., as the food items are being placed in a shopping cart (e.g., pears, yogurt, donuts, etc.). In various embodiments, the system may detect food items in a shopping list in connection with shopping online, shopping physically at a local supermarket, or a combination thereof.

In the online shopping example, to determine the food items, the system may obtain an electronic shopping list, where the food items are listed on the electronic shopping list. The system then reads the food items from the electronic shopping list.

In the physical shopping example, to determine the food items, the system may determine food items as the food items are scanned. For example, the food items may be scanned by a scanner, where the scanner scans an identifier or bar code affixed to the food item. The bar code may enable the system access information associated with the food item. To determine the food items, the system then receives scanned information associated with the food items. The particular techniques for determining food items may vary, and will depend on the particular implementation. For example, in some embodiments, the system may detect food items for purchase using radio frequency identification (RFID) technology, etc.

In some embodiments, the system may log the detected food items. The system may then compare the food items to food items in a purchase history in order to track new types of food items being purchased.

In various embodiments, the system may access a list of food items in a purchase history stored in a database and/or communicate with third-party vendors and/or reporting systems in order to obtain a shopping history. This enables the system to track new types of food items being purchased, as well as to determine purchase patterns.

At block 204, the system determines nutrients contained in the food items. In various embodiments, the system accesses a database with a predetermined list of nutrients for each type of food item. In various scenarios, the predetermined list may be based on raw food items (e.g., pears, bananas, etc.), as well as processed food items (e.g., packaged foods, etc.).

At block 206, the system determines nutrient values for each nutrient as the nutrient values decrease over time. In some embodiments, to determine the nutrient values for each of the nutrients, the system determines a quantity of each food item. For example, for each type of food item, they system may receive a quantity of food items and weight value of each of the food items. If a particular food item is a raw food item (e.g., pears), the system may receive a weight value from a weighing device. If a particular food item is packaged food item, the system may not need a weight value from the information associated with a scanned bar code or other identifier (e.g., RFID tag, etc.).

The system then determines the nutrient values for each nutrient based on the quantity of each food item. In various embodiments, the system decomposes the food items to be purchased into different nutrients. For example, a pear [symbol] may contain Octadecadienoic acid (e.g., 75.00 mg-333.70 mg/100 g), dietary fiber (e.g., 206 mg), etc. Donuts may contain fat (e.g., 18 g), sugars (e.g., 75 g), sodium (e.g., 1100 mg), etc.

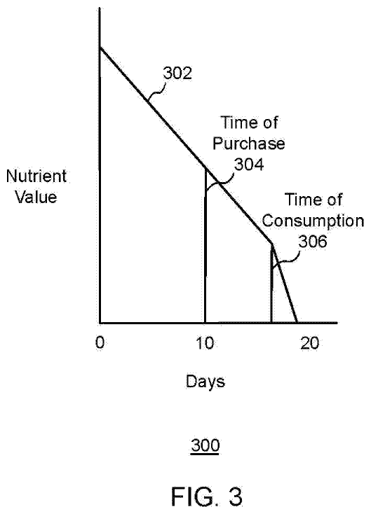

In various embodiments, the system determines the nutrient values at different phases in the life cycle of the food item. The system adds the decomposed nutrients to a consumption model. The system then generates a plot of each nutrient based on the time-of-purchase value and the time-of consumption value. In some embodiments, the plot shows the nutrient half-life of each nutrient over an attenuated consumption time period. Example embodiments are described in more detail herein in connection with FIG. 3, for example.

FIG. 3 is an example graph 300 showing the decrease in nutrient values of a food item over time, according to some embodiments. Shown is a plot or line 302 that shows how the nutrient value of a nutrient attenuates over time. Shown is the time of purchase 304, which is the purchase date. Because the food item is in the shopping cart, it may be presumed that the time of purchase is the current date. Also shown is the time of consumption 306, which is the date that the user consumes the food item. Graph 300 may represent the change in nutrient value of any given nutrient.

In various embodiments, the system determines a time-of-purchase value for each nutrient for each food item. The time-of-purchase value is the nutrient value at the time of purchase. This is significant in that the nutrient values of nutrients in food attenuate over time. In other words, the nutrient values of a given food item are lower at the time-of-purchase than when the food item is first packaged or available to be purchased. For example, the biological half-life of potassium may vary from 10 to 28 days. In another example, the vitamin-D half-life 1 to 6 weeks depending on a variety of conditions (e.g., the quantity of each nutrient, the presence of other nutrients, existing health conditions, etc.).

In some embodiments, for a given food item, the system estimates an amount of time that has passed between the time a food item was first packaged or available to be purchased and the current date that the food item is in the shopping cart. For example, the system may access information regarding when the food item was packaged. Such information may be available as a part of the information associated with a particular food item in an electronic shopping cart or associated with a scanned bar code on the packaging of a particular food item. Based on this time period, the system determines the time-of-purchase value for each nutrient for each food item. The time-of-purchase value is a downwardly adjusted nutrition value. Such a time-of-purchase value may be based on a predetermined half-life of a particular nutrient and the time that has passed since the food item was first packaged or available to be purchased.

In various embodiments, the system also determines a time-of consumption value for each food item. The time-of-consumption value is the nutrient value at the time of consumption. As indicated above, the nutrient values of nutrients in food attenuate over time. As such, the nutrient values of a given food item are lower at the time-of-consumption than at the time-of-purchase when the food item is purchased.

In some embodiments, for a given food item, the system estimates the amount of time that will pass between the time a food item is to be purchased and the estimated date that the food item will be consumed. For example, the system may access information regarding past purchases, including how frequently the food item is purchased (e.g., every 2 weeks, etc. Based on this time period, the system determines the time-of-consumption value for each nutrient for each food item. The time-of-consumption value is a downwardly adjusted nutrient value. In some embodiments, such a time-of-consumption value may be based on a predetermined half-life of a particular nutrient and the amount of time that is estimated to pass from the time the food item is purchased to the date of consumption. There may be various physiological and medical functions that determine the nutrient half-life. For example, in some embodiments, the system may have access to medical conditions of users, where the system may track the diet for those with dietary-produced conditions such as type 2 diabetes, or other conditions that are influenced by diet such as heart conditions, or other special nutrient needs, etc.

In some embodiments, the time-of-consumption may be estimated by crowd consumption patterns. For example, the time-of-consumption may be based on external information on how soon a typical consumer consumes a particular food after purchasing the food.

At block 208, the system aggregates the nutrient values for each nutrient. For example, the system may determine the nutrient values for a particular nutrient (e.g., vitamin D, etc.) and then aggregate those values across all food items. In various embodiments, the system may evaluate the aggregated nutrient value for each nutrient against a recommended or target nutrient value such as a nutrient value in a U.S. Food and Drug Administration (FDA) food pyramid or other suitable dietary requirements source.

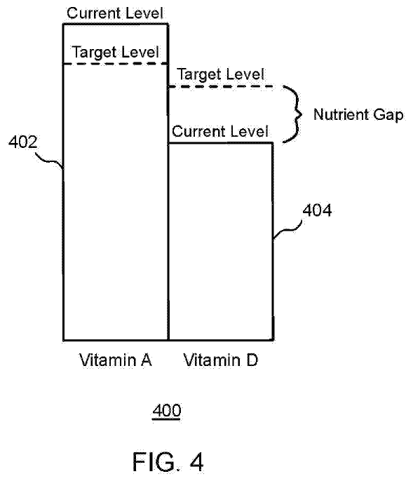

FIG. 4 is an example graph 400 showing current aggregate nutrient values compared to target nutrient values of two respective example nutrients, according to some embodiments. Shown is a bar 402 that represents the aggregated nutrient value of vitamin A (labeled “Current Level”) found across different food items in the shopping cart, and a target nutrient value or nutrition threshold of vitamin A (indicated with a dashed line in bar 402). Also shown is a bar 404 that represents the aggregated nutrient value of vitamin D (also labeled “Current Level”) found across different food items in the shopping cart, and a target nutrient value or nutrition threshold of vitamin D (indicated with a dashed line above bar 404).

In various scenarios, the food items are consumed over a certain time period (e.g., 5 days, 7 days, 9 days, etc.) depending on the consumption patterns of the user. Also, different food items are to be consumed during different meals and on different days. As such, the target levels may be averaged over the same time period. In some embodiments, the system may also obtain user input as to how much of each food item will be consumed in the coming week or predefined time period. In some embodiments, the system may also take into account the number of people in the household of the user. For example, if there are two people in the household, the system may adjust the target nutrient levels accordingly (e.g., doubling target nutrient levels for two people, tripling target nutrient levels for three people, etc.).

At block 210, the system determines if one or more of the aggregated nutrient values for one or more of the respective nutrients fall below respective nutrition thresholds. In some embodiments, the system determines the nutrition threshold for each nutrient, where the nutrition threshold is based on one or more of clinical data and exogenous data.

In various embodiments, the system determines missing nutrients and/or nutrient deficit or gaps for each nutrient that falls below the respective nutrition thresholds. In various embodiments, the nutrient deficit for a given nutrient is an amount that the given nutrient falls below the respective nutrition thresholds.

Referring still to FIG. 4, the current level of vitamin A exceeds the respective target level, and the current level of vitamin D is falls short of the respective target level. The amount that the current level of vitamin D is falls short of the respective target level may be referred to as a nutrition gap.

In some embodiments, the system may leverage clinical data such as blood pressure, electrolyte levels, bacteria levels, blood protein levels, etc. in order to determine nutrition thresholds. The system may also leverage exogenous data such as Internet of Things (IoT) data and other remote monitoring data (e.g., data from fitness apps, etc.) in order to determine nutrition thresholds.

For example, consumption of vitamin D is necessary to increase intestinal absorption of particular nutrients such as calcium, iron, magnesium, phosphate, zinc, etc. In a more specific example, vitamin D plays a key role in calcium homeostasis. Insufficient intake of vitamin D combined with lack of sunlight exposure adversely impacts absorption of other nutrients. Furthermore, many nutrients and medications have specific enterohepatic benefits. Potassium is another example. Potassium enables the nervous system, through the enterohepatic circulation where it flows through the system, and is flushed out or degraded in effectiveness. Maintaining a consistent and medically approved level maximizes a person's health.

In some embodiments, the system presents to a user each nutrient where the associated aggregated nutrient value falls below the respective nutrition threshold. For example, in some embodiments, the system may present a graph similar to FIG. 4 to the user. In some embodiments, the system may simply present a list of nutrients with nutrition gaps. In some embodiments, the system may also present the size of the nutrition gaps.

At block 212, the system recommends to a user one or more of the substitute food items or supplemental food items in order to close or eliminate nutrition gaps. In some embodiments, the system determines the one or more substitute food items or supplemental food items based on the nutrient deficit. In some embodiments, each nutrient is associated with a nutrient threshold.

In some embodiments, the system determines one or more food preferences of a user. For example, the user may dislike Brussels sprouts. The system may enable the user to indicate as such (e.g., like/dislike, thumbs up/thumps down, etc.). The system then recommends the one or more substitute food items or supplemental food items based on the food preferences. In some embodiments, the system maintains a purchase history in order refine suggestions over time in keeping with the user's preferences. The system may also use the crowd wisdom to suggest alternatives to poor selection presentation or poor ratings of the suggestion.

In various embodiments, by recommending substitute food items or supplemental food items, the system facilitates the user in making optimal food choices, which in turn helps the user in maintaining specific nutrients at optimal levels, which enhances overall health for the user. In some embodiments, the system may present targeted advertisements along with the recommendations. For example, the system may suggest particular food products to replace or supplement existing food items in the shopping cart.

In some embodiments, the system may recommend food items that are very similar but more nutritionally complete than current food items in the shopping cart or may recommend different brands that have more of the nutrient profile that is needed that week for a balanced nutrient menu.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Embodiments described herein provide various benefits. For example, embodiments facilitate a user in maintaining specific nutrients at optimal levels, which enhances overall health for the user.

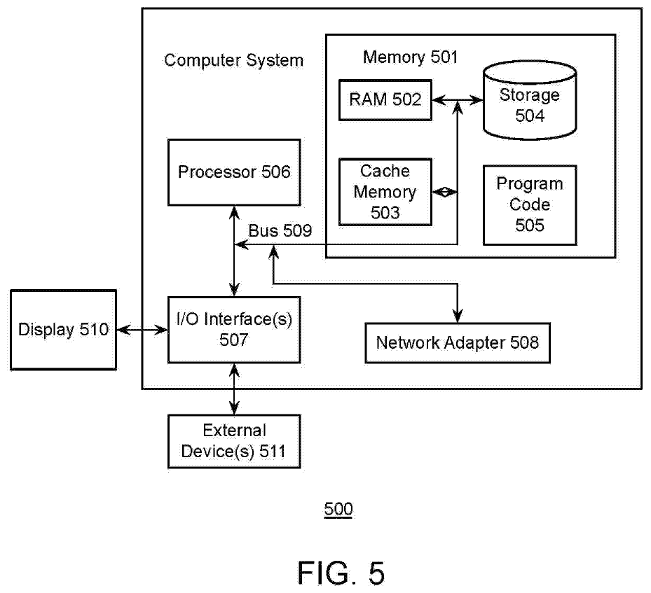

FIG. 5 is a block diagram of an example computer system 500, which may be used for embodiments described herein. The computer system 500 is operationally coupled to one or more processing units such as processor 506, a memory 501, and a bus 509 that couples various system components, including the memory 501 to the processor 506. The bus 509 represents one or more of any of several types of bus structure, including a memory bus or memory controller, a peripheral bus, an accelerated graphics port, and a processor or local bus using any of a variety of bus architectures. The memory 501 may include computer readable media in the form of volatile memory, such as random access memory (RAM) 502 or cache memory 503, or storage 504, which may include non-volatile storage media or other types of memory. The memory 501 may include at least one program product having a set of at least one program code module such as program code 505 that are configured to carry out the functions of embodiment of the present invention when executed by the processor 506. The computer system 500 may also communicate with a display 510 or one or more other external devices 511 via input/output (I/O) interfaces 507. The computer system 500 may communicate with one or more networks via network adapter 508.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
at least one processor and a computer readable storage medium having program instructions embodied therewith, the program instructions executable by the at least one processor to cause the at least one processor to perform operations comprising:
determining food items for purchase;
determining nutrients contained in the food items;
determining nutrient values for each nutrient as the nutrient values decrease over time;
aggregating the nutrient values for each nutrient;
determining if one or more of the aggregated nutrient values for one or more of the respective nutrients fall below respective nutrition thresholds; and
recommending to a user one or more of the substitute food items or supplemental food items.

2. The system of claim 1, wherein, to determine the food items, the at least one processor further performs operations comprising:
obtaining an electronic shopping list, wherein the food items are listed on the electronic shopping list; and
reading the food items from the electronic shopping list.

3. The system of claim 1, wherein the food items are scanned by a scanner, and wherein to determine the food items, the at least one processor further performs operations comprising receiving scanned information associated with the food items.

4. The system of claim 1, wherein, to determine the nutrient values for each of the nutrients, the at least one processor further performs operations comprising:
determining a quantity of each food item; and
determining the nutrient values for each nutrient based on the quantity of each food item.

5. The system of claim 1, wherein the at least one processor further performs operations comprising determining a nutrition threshold for each nutrient, wherein the nutrition threshold is based on one or more of clinical data and exogenous data.

6. The system of claim 1, wherein the at least one processor further performs operations comprising presenting to a user each nutrient where the associated aggregated nutrient value falls below the respective nutrition threshold.

7. The system of claim 1, wherein the at least one processor further performs operations comprising:
determining one or more food preferences of a user; and
recommending the one or more substitute food items or supplemental food items based on the food preferences.

8. A computer program product comprising a computer readable storage medium having program instructions embodied therewith, the program instructions executable by at least one processor to cause the at least one processor to perform operations comprising:
determining food items for purchase;
determining nutrients contained in the food items;
determining nutrient values for each nutrient as the nutrient values decrease over time;
aggregating the nutrient values for each nutrient;
determining if one or more of the aggregated nutrient values for one or more of the respective nutrients fall below respective nutrition thresholds; and
recommending to a user one or more of the substitute food items or supplemental food items.

9. The computer program product of claim 8, to determine the food items, the at least one processor further performs operations comprising:
obtaining an electronic shopping list, wherein the food items are listed on the electronic shopping list; and
reading the food items from the electronic shopping list.

10. The computer program product of claim 8, wherein the food items are scanned by a scanner, and wherein to determine the food items, the at least one processor further performs operations comprising receiving scanned information associated with the food items.

11. The computer program product of claim 8, wherein, to determine the nutrient values for each of the nutrients, the at least one processor further performs operations comprising:
determining a quantity of each food item; and
determining the nutrient values for each nutrient based on the quantity of each food item.

12. The computer program product of claim 8, wherein the at least one processor further performs operations comprising determining a nutrition threshold for each nutrient, wherein the nutrition threshold is based on one or more of clinical data and exogenous data.

13. The computer program product of claim 8, wherein the at least one processor further performs operations comprising presenting to a user each nutrient where the associated aggregated nutrient value falls below the respective nutrition threshold.

14. The computer program product of claim 8, wherein the at least one processor further performs operations comprising:
determining one or more food preferences of a user; and
recommending the one or more substitute food items or supplemental food items based on the food preferences.

15. A computer-implemented method for recommending food selections based on analysis of nutrients, the method comprising:
determining food items for purchase;
determining nutrients contained in the food items;
determining nutrient values for each nutrient as the nutrient values decrease over time;
aggregating the nutrient values for each nutrient;
determining if one or more of the aggregated nutrient values for one or more of the respective nutrients fall below respective nutrition thresholds; and
recommending to a user one or more of the substitute food items or supplemental food items.

16. The method of claim 15, wherein, to determine the food items, the method further comprises:
obtaining an electronic shopping list, wherein the food items are listed on the electronic shopping list; and
reading the food items from the electronic shopping list.

17. The method of claim 15, wherein the food items are scanned by a scanner, and wherein to determine the food items, the method further comprises receiving scanned information associated with the food items.

18. The method of claim 15, wherein, to determine the nutrient values for each of the nutrients, the method further comprises:
determining a quantity of each food item; and
determining the nutrient values for each nutrient based on the quantity of each food item.

19. The method of claim 15, wherein the method further comprises determining a nutrition threshold for each nutrient, wherein the nutrition threshold is based on one or more of clinical data and exogenous data.

20. The method of claim 15, wherein the method further comprises presenting to a user each nutrient where the associated aggregated nutrient value falls below the respective nutrition threshold.
